(19) United States
(12) Patent Application Publication
(10) Pub. No.: US 2012/0169692 A1
(43) Pub. Date: Jul. 5, 2012

(54) Micro Electromechanical System (MEMS) Spatial Light Modulator Pixel Driver Circuits

(76) Inventor: Ion E. Opris, San Jose, CA (US)

(21) Appl. No.: 12/983,198

(22) Filed: Dec. 31, 2010

(51) Int. Cl. G06F 3/038; G02B 26/00

(52) U.S. Cl. 345/211; 359/291

(57) ABSTRACT

We describe an analogue optical MEMS spatial light modulator (SLM) comprising optical phase modulating MEMS pixels each with a pixel electrode and a mirror mounted on a spring such that said mirror is able to translate in a direction perpendicular to said substrate substantially without tilting, under the influence of a voltage applied to said pixel electrode. The CMOS substrate comprises an analogue pixel driver circuit for each of the pixels to apply an analogue voltage to the pixel electrode. The analogue pixel driver circuit comprises a pixel voltage input to receive an analogue voltage, a first and second sample/hold circuits coupled to the pixel voltage input, and a multiplexer having respective inputs coupled to said first and second sample/hold circuits, an output coupled to the pixel electrode, and a select line to control said multiplexer to selectively couple said first and second S/H circuits to the pixel electrode.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright© 2010, Light Blue Optics Inc.

### BACKGROUND

1. Field

Embodiments of the present invention generally relate to pixel driver circuits for analogue optical MEMS (Micro Electromechanical System) spatial light modulators (SLMs), in particular piston-type MEMS devices in which the mirror moves perpendicularly to the substrate substantially without tilting.

2. Description of the Related Art

We have previously described various holographic image projection systems (see, for example, WO2007/141567), and more recently a holographic projector in which, broadly speaking, a holographically generated image is used for illumination of a second spatial light modulator (see, for example, WO2010/007404 and U.S. Ser. No. 12/182,095, which is hereby incorporated by reference in its entirety for all purposes). In this latter approach relatively low resolution phase modulation is employed to render lower spatial frequencies of an image holographically, the higher frequency components being rendered with an intensity modulating imaging panel placed in a plane conjugate to the hologram SLM. In such a system the hologram is preferably a fast, multiphase or quasi analogue-phase device, more particularly a pixellated MEMS (micro electromechanical system)—based piston actuated device.

There are special requirements for the pixel driver circuits of an analogue MEMS SLM in which the mirror may be moved by a variable analogue displacement corresponding to a variable analogue voltage applied to a pixel electrode of the device. In particular, because an analogue voltage drive is employed, it is desirable to achieve good linearity and low voltage droop. It is further desirable to be able to inject sufficient charge onto a pixel electrode to reach the target applied voltage in the allowed addressing time, in addition allowing the pixel mirror time to settle. This interacts with the pixel size and pixel drive voltage in a complex manner—a higher drive voltage dictates larger drive transistors, but it is also desirable (but not essential) that the pixel drive circuitry sits under a pixel to avoid the need to long interconnects between the drive circuitry and pixel electrodes if the drive circuitry is, for example, located to one side of the mirror array. The available space, which depends on the drive voltage and the optical mirror size, also provides a constraint on the complexity of the pixel driver circuitry (the number of both lower and “high” voltage transistors) and the number of power/control connections which can be fitted into the space, and this in turn also impact on parameters such as voltage droop and the accuracy and linearity of the mirror displacement (and hence also the number of bits in the digital-to-analogue converter, where one is employed).

Optically, in a diffractive image projection system, as opposed to a conventional system, it is desirable that the pixels should be small, because this increases diffraction angles from the SLM. For example preferably a pixel should be less than 30 μm by 20 μm. Accurate and repeatable control of the pixels is also important, and this imposes tight constraints on motion control—for example for five bit resolution at approximately 400 nm the phase steps are approximately 13 nm apart.

We will describe pixel driver circuits for analogue MEMS SLM devices, in particular for diffractive imaging applications, which address these problems and constraints.

### SUMMARY

According to a first aspect of the invention there is therefore provided an analogue optical MEMS spatial light modulator (SLM) comprising a substrate bearing a plurality of light modulating MEMS pixels, each of said light modulating pixels comprising a pixel electrode and a mirror mounted on a hinge or spring to provide an analogue variable displacement, wherein said substrate further comprises: an analogue pixel driver circuit for each of said optical phase modulating MEMS pixels coupled to said pixel electrode of the pixel, wherein said pixel driver circuit is configured to apply an analogue voltage to said pixel electrode to move said mirror by an analogue displacement; and wherein said analogue pixel driver circuit comprises a pixel voltage input to receive a said analogue voltage; a first sample/hold circuit coupled to said pixel voltage input and having a first sample/hold output, at least one select line coupled to said first sample/hold circuit to control sampling of said analogue voltage by said first sample/hold circuit, and a first capacitor coupled between said pixel voltage input and said first sample/hold output to store said sampled voltage.

In embodiments using at least one sample/hold circuit per pixel enables the pixel deflection to remain stable for a large proportion of the frame period. Further since the load is essentially capacitive and it is important to minimise power dissipation, in one approach a passive sample/hold circuit is employed, although preferably two select/sample transistors are used to reduce the voltage range loss which could otherwise result from the body effect on the switching threshold of the transistors. More preferably, however, both row and column select/sample transistor pairs are included.

One disadvantage of a ‘passive’ sample/hold circuit is pedestal error due to charge injection. To address this one approach is to make the sample/hold capacitor at least 5 times or 10 times greater than the MOS gate capacitance of the select transistor or transistors.

In one approach to driving the circuit the desired analogue voltage to be stored on the sample/hold capacitor is set on a data line, the row/column select transistor(s) are activated to write the analogue voltage on to the sample/hold capacitor, and then at least one of the select transistor switches is opened for row-by-row writing. In an example device there may be 144×144 or 160×160 pixels and for a target frame rate (3 colour) of say 5760 frames per second that is around 170 μs per frame. This provides approximately 1 μs to write a row of pixels (noting that the columns may be driven simultaneously). A 5% (of 170 μs) mechanical mirror settling time, allows around 8-10 μs for a mirror to settle. However if it is desired to write data to a row in 5% of a row time, this only allows around 50-60 ns to write a row. In embodiments the drive voltage range may be between 0 and 10-15 volts and this drive voltage should preferably be achieved within this 60 ns time, taking into account pixel/electrode line resistance and capacitance.

In some preferred embodiments of the device one or more digital-to-analogue (D/A) converters are provided each for providing analogue voltage data to the pixel voltage inputs for a row or column of the SLM. There may be many D/A converters, for example one per n rows or columns, where n<10 or n=1. A D/A converter may include a resistor string with resistor values chosen to compensate for non-linearity in the response (displacement versus voltage) of a MEMS pixel mirror.

As discussed, in embodiments it is desirable to achieve close to the required analogue pixel electrode voltage in around 5% of the row/column drive time, which effectively means driving the pixel electrode capacitance with a current of 20 times what it would be were the entire row drive time available. This in turn dictates large transistors in the digital-to-analogue converter(s).

Therefore in some preferred embodiments the pixel driver circuit includes a second sample/hold circuit also coupled to the pixel voltage input, and a multiplex circuit to select between outputs of the first and second sample/hold circuits. In this way one SLM frame may be written to one set of sample/hold circuits while the other set of sample/hold circuits drives the pixels of the display, and vice versa. This effectively provides a complete frame interval for the SLM to be updated, broadly speaking enabling the digital-to-analogue circuitry to be shrunk by a factor of around 20. This is particularly important where relatively high drive voltages, such as voltages up to 10-15 volts, are employed to drive the MEMS pixels, since transistors for these voltages are large.

In embodiments portions in particular one or more select transistors, of the sample/hold circuitry may be common to the first and second sample/hold circuits for a pixel, to reduce the area of the pixel driver circuitry.

With such an approach the SLM updates relatively slowly, but switches fast, maintaining optical efficiency. In embodiments of the imaging system it may be preferable to blank illumination of the SLM during switching of the multiplexer controller lines to switch the pixel drive from one set of sample/hold circuits to the other. In some preferred image display systems pulse width modulation (PWM) control of the illumination of the SLM is employed, in which case this blanking may simply comprise an adjustment of the pulse length of a PWM illumination control waveform. Similarly in some preferred applications, sequential illumination of the SLM by different colours is employed to provide a multi-colour display, and thus the blanking may be incorporated into a procedure for switching between the different colours of illumination of the SLM. However blanking of the illumination may not be essential, particularly in a diffractive imaging system in which the SLM displays a diffraction pattern which generates an image, or an illumination pattern for a second SLM.

In a related aspect the invention provides an analogue optical MEMS spatial light modulator (SLM) comprising a substrate bearing a plurality of optical phase modulating MEMS pixels, each of said MEMS pixels comprising a pixel electrode and a mirror mounted on a spring such that said mirror is able to translate in a direction perpendicular to said substrate substantially without tilting, under the influence of a voltage applied to said pixel electrode, wherein said substrate further comprises: an analogue pixel driver circuit for each of said optical phase modulating MEMS pixels coupled to said pixel electrode of the pixel, wherein said pixel driver circuit is configured to apply an analogue voltage to said pixel electrode to translate said mirror by an analogue displacement in said perpendicular direction; and wherein said analogue pixel driver circuit comprises: a pixel voltage input to receive a said analogue voltage; a first sample/hold circuit coupled to said pixel voltage input and having a first sample/hold output; a second sample/hold circuit coupled to said pixel voltage input and having a second sample/hold output; first and second sample/hold select lines coupled to said first and second sample/hold circuits; and a multiplexer having respective inputs coupled to said first and second sample/hold outputs, having a multiplexer output coupled to said pixel electrode, and having at least one multiplexer select line to control said multiplexer to selectively couple said first and second sample/hold outputs to said pixel electrode.

Again In some preferred embodiments the analogue optical MEMS SLM is incorporated into an image display system, in particular a diffractive image display system, in combination with a display controller configured to control the select lines for the two sets of sample/hold circuits. The controller controls the MEMS SLM to write image display data for first and second image frames, writing one whilst displaying the other (noting that the ‘image’ displayed on the SLM is, in some preferred implementations, a diffraction pattern or hologram).

### BRIEF DESCRIPTION OF THE DRAWINGS

These and other aspects of the invention will now be further described, by way of example only, with reference to the accompanying figures, in which:

FIG. 1 shows a 3D perspective view, with cutaway portions, of a portion of an optical phase modulating MEMS SLM;

FIG. 2 shows an example of a holographic image projection system in which the MEMS SLM of FIG. 1 may be employed;

FIG. 3 shows a first analogue pixel driver circuit for a MEMS SLM, including a sample/hold circuit, according to an embodiment of the invention;

FIG. 4 shows a second analogue pixel driver circuit for a MEMS SLM, including an improved sample/hold circuit, according to an embodiment of the invention;

FIG. 5 shows a third analogue pixel driver circuit for a MEMS SLM, including a sample/hold circuit with row and column switches, according to an embodiment of the invention;

FIG. 6 shows a fourth analogue pixel driver circuit for an MEMS SLM, including a dual sample/hold circuit, according to an embodiment of the invention;

FIG. 7 shows a fifth analogue pixel driver circuit for a MEMS SLM, including a dual sample/hold circuit implemented using only NMOS devices, according to an embodiment of the invention;

FIG. 8 shows an example level shift circuit for use with a pixel driver circuit according to an embodiment of the invention;

FIG. 9 shows an example implementation of a digital-to-analogue converter for use with an analogue MEMS spatial light modulator including a pixel circuit of the type shown in any of FIGS. 3 to 7; and

FIG. 10 shows a holographic image display system including an analogue optical phase modulating MEMS SLM according to an embodiment of the invention.

### DETAILED DESCRIPTION

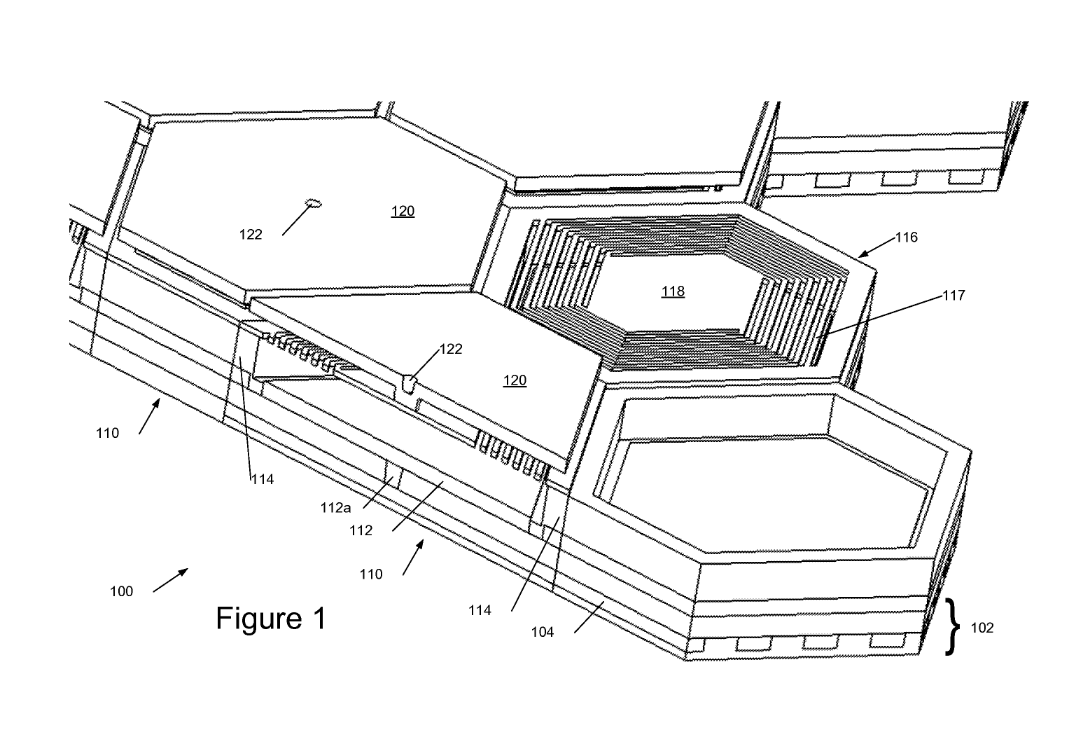

Referring first to FIG. 1, this shows a cutaway portion of an optical phase modulating MEMS SLM 100 prior to attaching a glass window over the MEMS pixels.

In the example of FIG. 1 each electrostatically-actuated pixel is approximately 10×10\sqrt{2}μm and deflects over 400 nm when actuated with 1 volts, has 8 nm of deflection resolution, settles within 30 μs, and has the shape of an irregular hexagon. The mirror spring comprises a single crystal silicon (SCS) electromechanical flexure serving as both a spring/mirror mount and as a top electrode.

Thus in some preferred embodiments the SLM 100 comprises a substrate 102 bearing a plurality of SLM pixels 110. For display devices, individual addressing of mirror actuators is generally desirable, and this may be achieved by incorporating CMOS circuitry underneath each actuator. Thus substrate 102 is preferably a CMOS substrate and a bottom pixel electrode 112 may comprise a portion of an exposed top metal layer of the CMOS substrate with a via 112a connection to one or more underlying metal layers 104 of the CMOS substrate.

A MEMS pixel 110 also comprises a spring support structure 114, as illustrated an oxide wall, around the perimeter of the bottom pixel electrode 112. The spring support structure 114 supports a mirror spring 116 comprising a mirror support 118 and a plurality of mirror spring arms 117 each extending between mirror support 118 and the spring support structure 114. In the preferred embodiment illustrated each mirror spring arm has a spiral shape. The mirror spring 116 is electrically conductive and acts as a second, top electrode of the MEMS pixel structure. In operation a voltage applied between the bottom 112 and top 116 pixel electrodes generates an electrostatic force which results in translation (piston-type motion) of the mirror support 118.

The pixel further comprises a mirror 120 mounted on the mirror support 118 and attached to this support by a ‘stitch’ or via (which leaves a dimple artefact 122 in the centre of the mirror). In embodiments the mirror spring 116 may optionally be attached to the substrate or spring support structure by another ‘stitch’ or via (not shown in FIG. 1). For example where the mirror spring comprises SiGe, the SiGe may be deposited into a trench extending down to the underlying silicon substrate.

When fabricating the structure of FIG. 1, the CMOS drive circuitry is constructed first and the MEMS actuator afterwards, and thus the MEMS fabrication should be compatible with CMOS, in particular processing temperature limitations (a maximum processing temperature of 425° C.). The mirror spring should exhibit good mechanical reliability and preferably its properties should not change significantly in 10¹⁰ or more cycles. Most metals and metal alloys do not satisfy these desirable requirements and whilst silicon based films such as polysilicon can exhibit this level of mechanical reliability, polysilicon requires high deposition temperatures which are incompatible with the CMOS temperature requirements.

Silicon (Si) germanium (Ge) alloys, in particular compositions having a high germanium content, for example greater than 65%, can have low deposition temperatures (down to 370° C.) and excellent mechanical properties that include low stress and low creep. High electrical conductivity can also be obtained with SiGe alloys, either with n-type or p-doping.

The preferred microstructure for mechanically reliable SiGe films is polycrystalline microstructure or a mixture of amorphous and crystalline phases. A preferred deposition method for deposition of SiGe films is chemical vapour deposition (CVD) from silane and germane. An alternative deposition method for these films is plasma enhanced chemical vapour deposition (PECVD). This can be performed at even lower deposition temperatures than CVD although the mechanical properties are not as favourable as for CVD films.

Electrostatic actuators using SiGe alloys as the functional material are compatible with fabrication of the CMOS substrate first, and also are able to provide the other desirable properties for display applications mentioned above. In one approach polycrystalline SiGe is deposited at, for example, 385° C. or less over a silicon seed layer (provided from a disilane deposited film). Optionally annealing such as laser annealing may be employed to reduce grain size and RMS roughness. Another less preferable option is to use polycrystalline germanium, which can self-anneal, but this material is less stable over time and also prone to attack by moisture. A further possibility is to employ an amorphous silicon mirror spring optionally again with a laser or low temperature annealing process.

For further details reference may be made to our co-pending U.S. patent application Ser. No. ______ entitled “Spatial Light Modulators and Fabrication Techniques” and filed on the same day as the present application, which is hereby incorporated by reference in its entirety for all purposes.

### Example Holographic Image Protection System

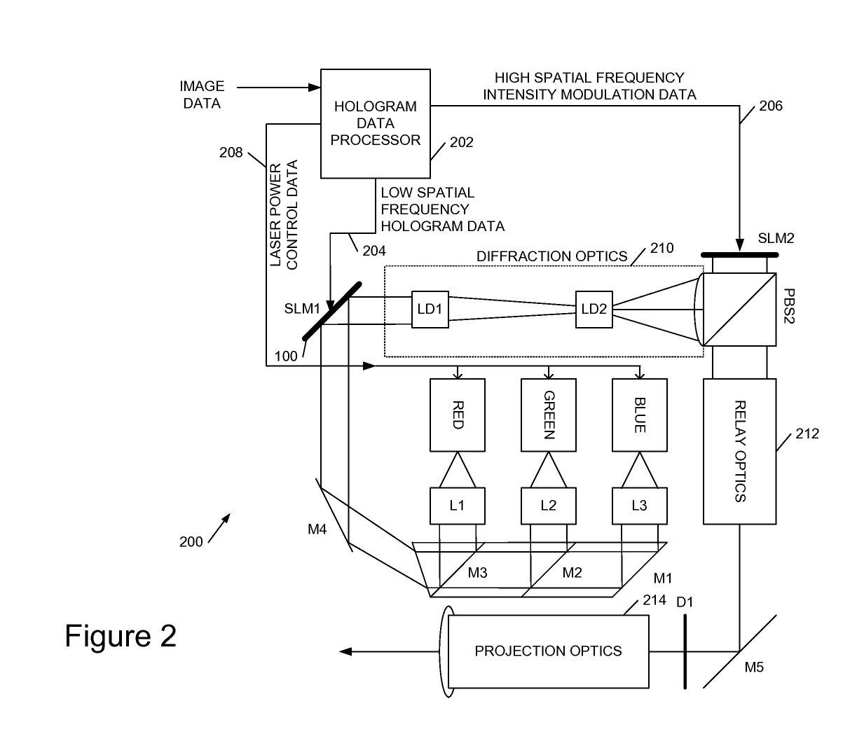

FIG. 2 shows an example holographic image projection system architecture 200 in which the SLM may advantageously be employed. The architecture of FIG. 2 uses dual SLM modulation—low resolution phase modulation and higher resolution amplitude (intensity) modulation. This can provide substantial improvements in image quality, power consumption and physical size. The primary gain of holographic projection over imaging is one of energy efficiency. Thus the low spatial frequencies of an image can be rendered holographically to maintain efficiency and the high-frequency components can be rendered with an intensity-modulating imaging panel, placed in a plane conjugate to the hologram SLM. Effectively, diffracted light from the hologram SLM device (SLM1) is used to illuminate the imaging SLM device (SLM2). Because the high-frequency components contain relatively little energy, the light blocked by the imaging SLM does not significantly decrease the efficiency of the system, unlike in a conventional imaging system. The hologram SLM is preferably be a fast multi-phase device, for example a pixellated MEMS-based piston actuator device.

In FIG. 2:
SLM1 is a pixellated MEMS-based piston actuator SLM as described above, to display a hologram—for example a 160×160 pixel device with physically small lateral dimensions, e.g <5 mm or <1 mm.
L1, L2 and L3 are collimation lenses (optional, depending upon the laser output) for respective Red, Green and Blue lasers.
M1, M2 and M3 are dichroic mirrors a implemented as prism assembly.
M4 is a turning beam mirror.
SLM2 is an imaging SLM and has a resolution at least equal to the target image resolution (e.g. 854×480); it may comprise a LCOS (liquid crystal on silicon) panel.
Diffraction optics 210 comprises lenses LD1 and LD2, forms an intermediate image plane on the surface of SLM2, and has effective focal length f such that fλ/Δ covers the active area of imaging SLM2. Thus optics 210 perform a spatial Fourier transform to form a far field illumination pattern in the Fourier plane, which illuminates SLM2.
PBS2 (Polarising Beam Splitter 2) transmits incident light to SLM2, and reflects emergent light into the relay optics 212 (liquid crystal SLM2 rotates the polarisation by 90 degrees). PBS2 preferably has a clear aperture at least as large as the active area of SLM2.
Relay optics 212 relay light to the diffuser D1.
M5 is a beam turning mirror.
D1 is a diffuser to reduce speckle.
Projection optics 214 project the object formed on D1 by the relay optics 212, and preferably provide a large throw angle, for example >90°, for angled projection down onto a table top (the design is simplified by the relatively low entendue from the diffuser).

The different colours are time-multiplexed and the sizes of the replayed images are scaled to match one another, for example by padding a target image for display with zeros (the field size of the displayed image depends upon the pixel size of the SLM not on the number of pixels in the hologram).

A system controller and hologram data processor 202, implemented in software and/or dedicated hardware, inputs image data and provides low spatial frequency hologram data 204 to SLM1 and higher spatial frequency intensity modulation data 206 to SLM2. The controller also provides laser light intensity control data 208 to each of the three lasers. For details of an example hologram calculation procedure reference may be made to WO2010/007404 (hereby incorporated by reference in its entirety for all purposes).

### Example MEMS SLM

In one purely illustrative example the MEMS SLM has a 144×144 array of active pixels, with each pixel size about 14 μm×10 μm. The entire pixel array is refreshed every 208 μs. Each pixel mirror has maximum deflection of 400 nm with an absolute accuracy of +/−4 nm and an 8 nm step. The pixel actuation voltage can be calibrated digitally at the system level. The total number of deflection levels (after calibration) is therefore less than 25 (typically 22). However, the deflection is non-linear with the actuation voltage. With a linear D/A converter, a 7- or 8-bit D/A converter is therefore desirable. The exact deflection vs. actuation voltage may be determined experimentally.

Another important parameter for the MEMS mirror array is the settling time. Although the refresh rate is fixed (for example at 208 μs), it is desirable to have a refresh time as short as possible to maximize the active duty cycle. A mechanical settling time may be about 20 μs (10% of the frame period). The drive circuit should have a switch time between frames shorter than 10% of the frame period (20 μs), but preferably much shorter.

The actual MEMS load is a very small capacitance of the pixel pad (less than 10 fF). The displacement charge in the pixel capacitance due to mechanical pump action can be estimated by modelling as a parallel plate capacitor with 140 μm² plate area and a capacitor distance of 2 μm (going down to 1.6 μm for a 400 nm displacement) with a capacitance of about 0.15 fF.

The basic low voltage process technology may be chosen to be 0.18 μm, as a compromise between wafer cost and low voltage circuitry area (mainly memory and I/Os). The high voltage elements are determined primarily by the actuation voltage and available technology node. Physical design (layout) rules imply restrictions on the minimum size MOS device and device-to-device minimum separations. For example a 1.2 μm technology has a maximum voltage of 12 volts.

Another important high-voltage component is the capacitor. A MOS gate capacitor has a capacitance density roughly inversely proportional to the maximum voltage, going from about 0.5 fF/μm² for a 3 μm/32 V technology, to 2.5 fF/μm² for a 0.5 μm/5 V technology.

Met1 and met2 may be used for routing, while meth (the upper most metal layer) may be used for pixel electrode. Therefore 3-4 metal layers can be dedicated to an interdigitated metal capacitor with an area efficiency of about 0.5 fF/μm². The low voltage I/Os handle the data transfer for each frame refresh, or about 144*144/208 pixels/μs ˜100 Mpixels/s. Assuming 8-bit per pixel, the total memory size may be about 144×144×8 bits ˜165 Kbit dual access (read while write) SRAM. In a portable display application it is desirable to minimise power dissipation: a rough estimate of 4 pF of equivalent moving capacitance per bit leads to a power dissipation of about C*V2*f˜10 mW.

### MEMS SLM Pixel Driver Circuits

Each analogue pixel deflection should remain stable for a large proportion of the frame period so a dedicated sample and hold (S/H) circuit is used for each pixel. Since the load is essentially capacitive and since it is important to aim to minimise the power dissipation, a passive sample/hold circuit is desirable (passive in the sense that the circuit does not employ active amplification in, for example, the sampling circuit).

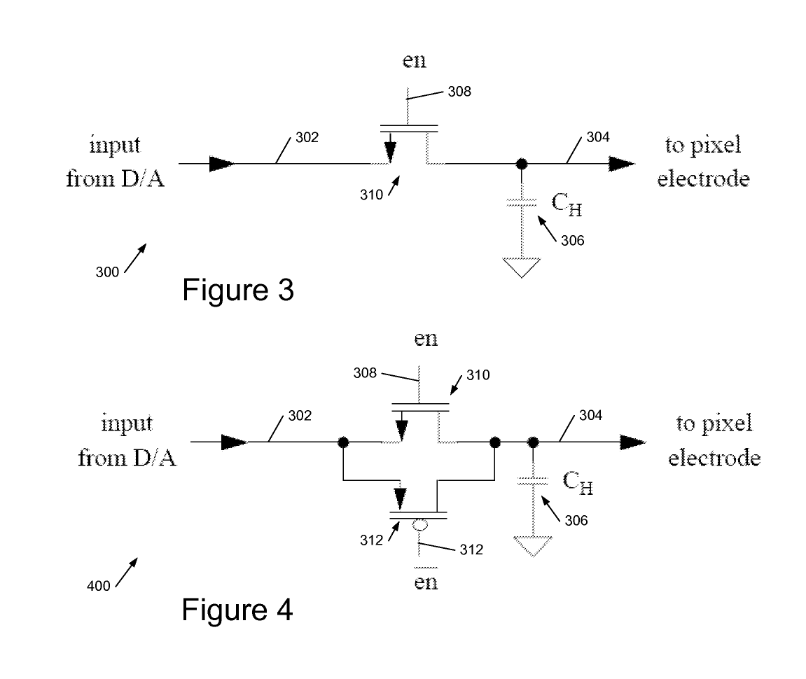

Referring now to FIG. 3, this shows an analogue MEMS pixel driver circuit 300 comprising a single MOS transistor 310. The circuit has an analogue voltage input 302 from a digital-to-analogue converter and provides an analogue voltage sample/hold output 304 to drive the MEMS pixel electrode, electrode 112 in FIG. 12. A single control (enable) line 308 is employed per pixel, and this is connected to the gate of MOS transistor 310 to selectively couple the voltage input 302 to a MOS hold capacitance 306 which is connected to line 304.

One problem with the circuit of FIG. 3 is that this circuit suffers from a reduced available voltage range due to the body effect on the threshold of the MOS switch 310. The voltage range loss may be about 30-35% of the high voltage (for example, 10-12 volts) supply, which is undesirable.

FIG. 4 shows an improved analogue MEMS pixel driver circuit 400 employing a sample/hold circuit with a complementary CMOS switch. In FIG. 4, like elements for those of FIG. 3 are indicated by like reference numerals. In the circuit of FIG. 4 an additional, complementary MOS transistor 302 is connected in parallel with transistor 308 and an additional control (enable) line 314 is employed.

Depending upon the design rules, and in particular on the minimum metal pitch, and also on the MEMS SLM pixel pitch (lateral dimensions) and number of pixels, there may or may not be room to route the two control signals per pixel to the pixels in the centre of the array. Although it is desirable to locate the pixel driver circuits under their respective pixels, in an alternative approach the outputs of the pixel driver sample hold circuits may be routed to the pixel electrodes from outside the MEMS pixel array, reducing the number of routing lines needed. One disadvantage of such an approach is the large coupling capacitance between pixels, and therefore to reduce the cross-talk the hold capacitance may be increased and/or all of the pixels in a row/column should be set and sampled simultaneously (the latter being preferable so that very large hold capacitances are not employed).

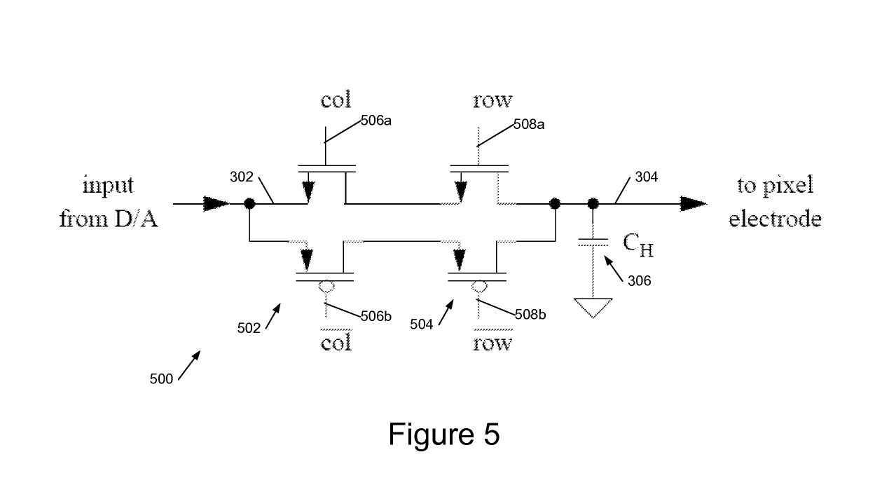

FIG. 5 shows an embodiment of an analogue MEMS SLM pixel driver circuit 500 which addresses these difficulties by employing two pairs of complementary CMOS switches 502, 504 in series. Again like elements to those previously described are indicated by like reference numerals.

In the arrangement of FIG. 5 a pair of complementary row select signals 508a, b is provided connected to the gates of respective row select lines, and a pair of complementary column select lines 506a, b is also provided, connected to the gates of respective switching transistors. The circuit of FIG. 5 can be used under a respective MEMS pixel since the four row/column control signals can be grouped on rows and columns. In this way pixel cross talk may be kept small.

One disadvantage of a passive sample/hold circuit as described is pedestal error due to charge injection—broadly speaking when a select transistor is on the gate capacitance is charged and when it is turned off this charge splits, via the channel under the gate, between the source and drain electrodes causing a voltage shift or pedestal error. The charge injection is roughly half of the channel charge and is dependent on the gate capacitance, gate voltage and threshold voltage. Since only the threshold voltage has significant temperature dependence, and since the other parameters can be calibrated out, it is preferable that the hold capacitance is significantly larger than the gate capacitance. For example if the hold capacitance, C_{H} is around 10 times larger than the MOS gate capacitance the effects of the pedestal error are relatively small after an initial calibration and the total useful voltage range is not significantly affected.

A second limitation on the size of the hold capacitor is voltage droop due to leakage. For example for a hold capacitor value around 60 fF and an acceptable voltage droop of around 40 mV in a frame period of around 200 μs, a leakage current of around 10 pA is tolerable—if this is higher then the frame may be refreshed more frequently, albeit with an increase in power dissipation.

The analogue pixel driver circuit 500 of FIG. 5 is refreshed during a short interval in the frame period so a power spike will occur during this refresh interval. For example, if 10% of the frame period is used for electronic refresh, the peak power may reach 10 times the average power in the high voltage circuits.

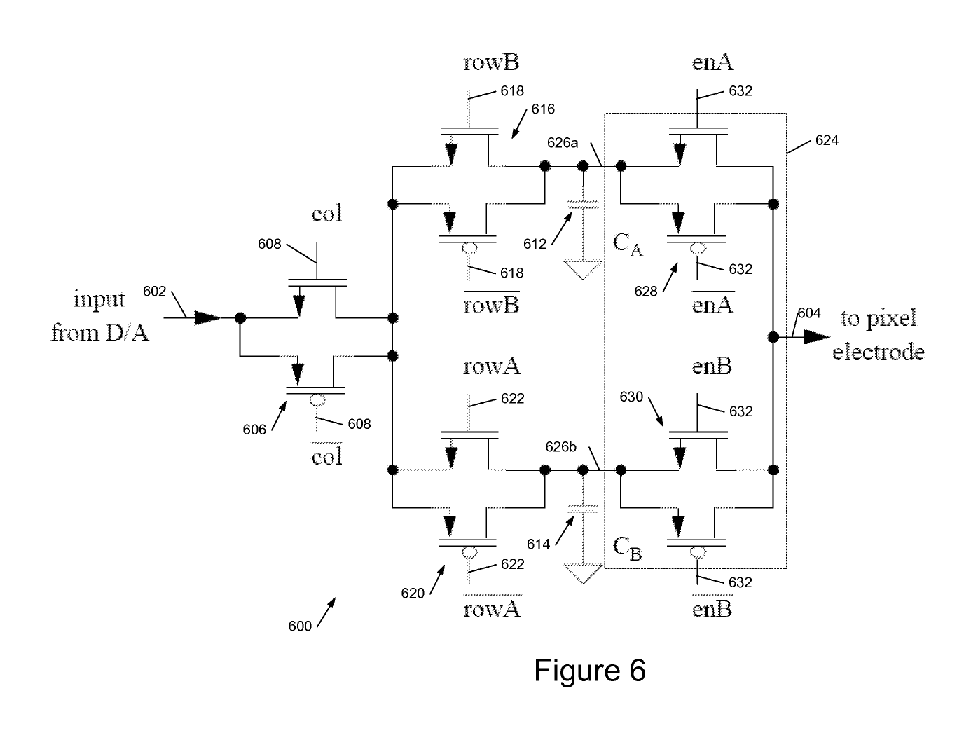

FIG. 6 shows an analogue MEMS SLM pixel driver circuit 600 which addresses this difficulty and avoids such large power peaks, at the expense of a more complex circuit.

Again this circuit has an analogue voltage input 602, for example from a digital-to-analogue converter, and an analogue voltage drive output 604 to the MEMS pixel electrode 112. In the embodiment of the circuit illustrated in FIG. 6 a pair of column select transistors 606 is provided controlled by complementary control lines 608, and coupled between the voltage input 602 and a pair of hold capacitors 612, 614 each forming part of a respective sample hold circuit. Two pairs of row select transistors 616, 620 each with a respective pair of complementary control lines 618, 622 controlled by different pairs of row select signals, are provided. One pair of row select transistors 616 is connected in series between the column select transistors 606 and the first hold capacitor 612, and the second pair of row select transistors 620 is connected in series between the column select transistors 606 and the second hold capacitor 614. Thus transistors 606, 616 and capacitor 612 form a first sample hold circuit, and transistors 606, 620 and capacitor 614 form a second sample hold circuit, with the column select transistors 606 being shared between the two sample hold circuits. In embodiments of the circuit of FIG. 6 the column select transistors 606 and corresponding control lines 608 are optional, since there could, for example, be one digital-to-analogue voltage drive provided per column.

The circuit 600 of FIG. 6 also includes an output multiplexer 624 having a pair of inputs 626a, b connected to the sample/hold outputs of the respective first and second sample/hold circuits, and having an output connected to the pixel electrode drive line 604. The multiplexer 624 comprises first and second pairs of complementary switching transistors 628, 630 controlled by the same pair of control lines 632 such that when one of switches 628, 630 is on the other is off and vice versa.

The output multiplexer 624 allows the output of one sample to sample/hold circuit to be directed to the pixel electrode whilst the other sample/hold circuit is being written to, and thus enables alternate sample/hold circuits to be written in alternate frames. Thus in operation the columns select lines 608 and the row select lines 618 of, say, the first sample hold circuit are activated to write data from line 602 onto the first hold capacitor 612 whilst the control lines 632 of output multiplexer 624 are controlled to couple the voltage on the second hold capacitor 614 to the output 604. Then once a complete frame of pixel data has been written to the set of first sample/hold circuits the multiplexer 624 is controlled to couple the outputs of the circuits to their respective pixel electrodes and lines 608 and 622 of the second sample hold circuits are selected to write analogue voltage data to the respective second hold capacitors 614.

The circuit of FIG. 6 can thus load the next frame value while outputting the current frame data. This circuit uses 4 global control signals (enA, enA, enB, and enB on the Figure), 2 column controls and 4 row controls, split into 2 row controls for alternate frames. The two hold capacitors (C_{A} and C_{B} in the Figure) can be implemented in metal with a value of, say, about 60 fF each for a 140 μm² pixel area. The frames can switch very fast, so the frame refresh period can be as long as the frame period itself, without loss of illumination (laser) efficiency due to electronic refresh (although some loss due to mechanical settling is still likely).

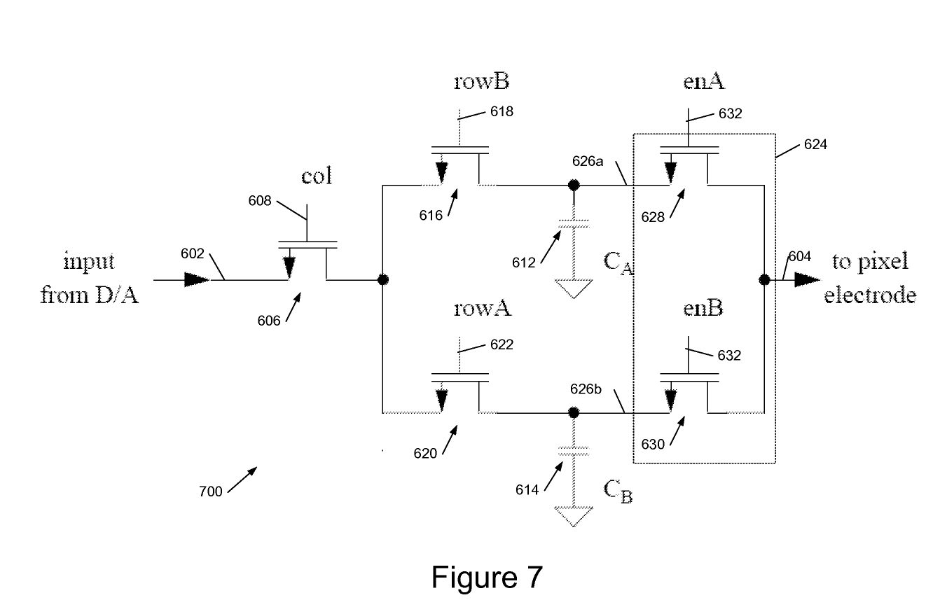

An analogue MEMS pixel driver circuit of the type shown in FIG. 6 can, alternatively, be implemented using only 5 NMOS devices, as illustrated in the pixel driver circuit 700 of FIG. 7. In FIG. 7 like elements to those of FIG. 6 are indicated by like reference numerals. As can be seen, broadly speaking the complementary CMOS switches are each replaced by a single NMOS device. With such an approach the usable output voltage range is reduced due to the body effect of the MOS devices (if, say, the source voltage approaches the gate drive voltage the transistor starts ceasing to conduct, limiting the available pixel drive voltage). Nonetheless this approach may be desirable depending, for example, on space limitations, the process technology node (geometry size) and desirable maximum actuation voltage. More particularly the circuit of FIG. 7 can lead to a reduced physical circuit area and power consumption. This is because a reduced number of high voltage devices is used and, moreover, since all these devices are of the same type (polarity), this avoids the significant separation between high voltage NMOS and PMOS devices of the arrangement of FIG. 6, whilst still providing fast switching between frames.

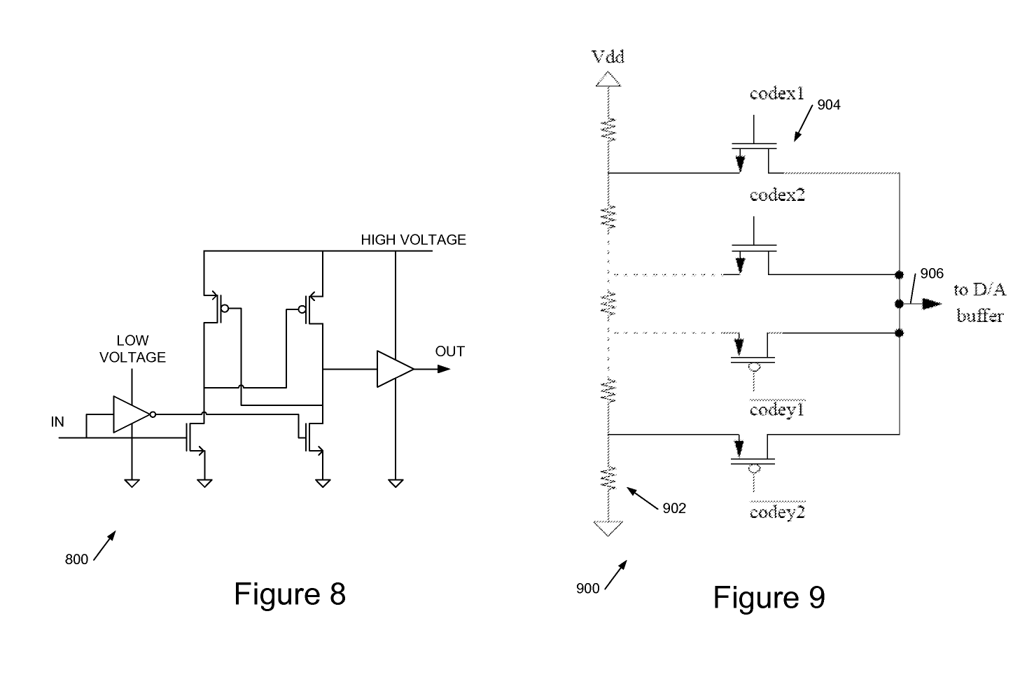

Depending upon the available area for a pixel driver circuit, and in particular whether more high voltage MOS devices can fit within the available pixel area, other sample/hold circuit configurations may be employed to further reduce the power dissipation. In particular the row/column selection may be performed at low voltage and one or more level shifts used locally, after pixel decoding, to thereby reduce the load switched at high voltage. An example of such a level shift circuit 800 is shown in FIG. 8. Broadly speaking, if one cross-driven pair of transistors is on the other is off, and vice-versa, so that there is substantially no dc power dissipation. The skilled person will be aware of other examples of level shift circuit which may be employed. A disadvantage is that a level shift circuit generally employs at least four MOS devices, so that a sample/hold circuit of the type shown in FIG. 6 or 7 would employ a relatively large number of high voltage devices.

FIG. 9 shows one example of a digital-to-analogue converter circuit 900 which may be employed with the previously described pixel driver circuits. In this example circuit example a resistor string 902 is employed with a set of MOS switches 904 at a set of tap points on the resistor string. A significant advantage of this circuit is that the taps do not have to be equally spaced on the resistor string, and thus the voltage levels at output 906 of the digital-to-analogue converter may be a non-linear mapping of the digital value input to the analogue output voltage, in particular warped to match the characteristic of a MEMS pixel of the spatial light modulator to provide a substantially linear displacement of the mirror in response to the digital input value. Thus some preferred embodiments of the MEMS SLM incorporate one or more analogue-to-digital converters in which the mirror displacement is substantially linearly dependant upon the digital input value to the digital-to-analogue converter, and in which the digital-to-analogue converter applies a non-linear mapping between the digital input value and the analogue output voltage drive in a pixel electrode of a MEMS pixel electrode of a MEMS pixel in order to compensate for non-linearities in the displacement of the MEMS pixel mirror in response to the applied analogue voltage on the pixel electrode.

In embodiments, even though providing non-linear taps can significantly reduce the D/A resolution needed for a desired position of accuracy of the pixel mirror it is preferable that the D/A resolution is still greater than that theoretically required, to provide some margin for error. Optionally if a digital-to-analogue converter is not needed for a period of time it may be powered down for power saving. Optionally, but preferably, the output 906 drives a pixel driver circuit via a buffer, to facilitate driving the relatively large capacity of load of a pixel driver circuit. This reduces the area and power requirements for a given load and settling time. Again a D/A buffer may be powered down if unused for a period of time.

In some preferred embodiments of an analogue optical MEMS SLM including pixel driver circuits as described above, a high-voltage charge pump is provided on the SLM substrate (with connections to off-chip inductor and capacitors for efficiency). This facilitates provision of the 10-12 volts which is typically needed.

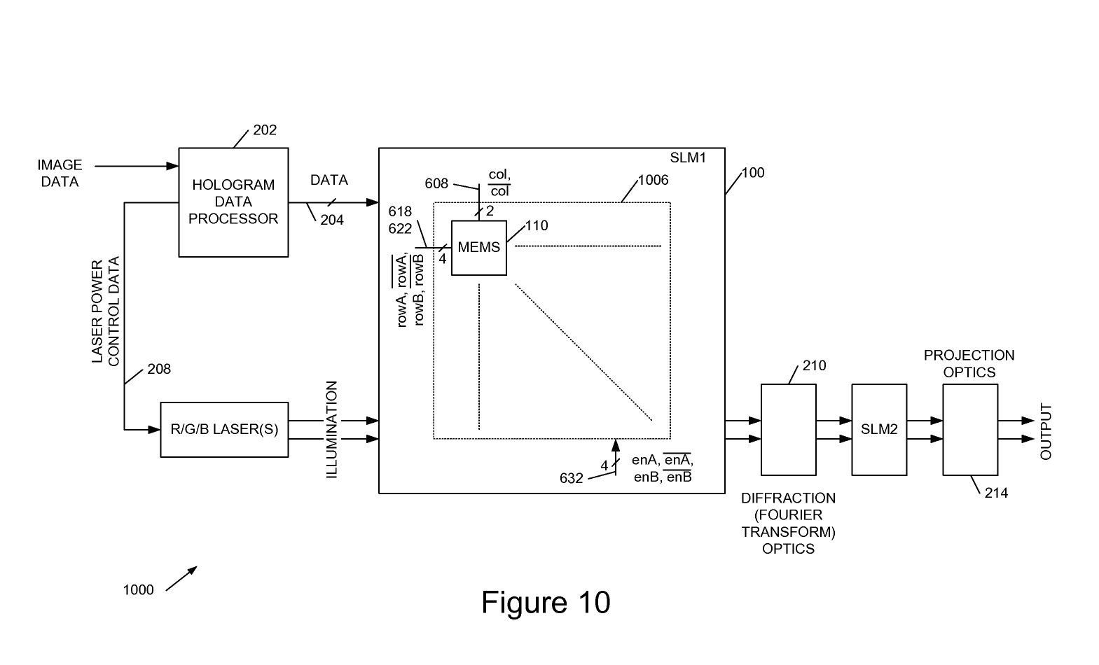

Referring now to FIG. 10, this shows, schematically, a holographic image display system 1000 of the type shown in FIG. 2, incorporating an optical phase modulating MEMS SLM with pixel driver circuitry as previously described with reference to FIG. 6. In FIG. 10 like elements of those of FIGS. 2 and 6 are indicated by like reference numerals.

Active matrix MEMS pixel 110 has a complementary pair of column select lines 608, and two complementary pairs of row select lines 618, 622 for selecting either frame A or frame B sample/hold circuits. The active matrix pixel region 1006 also has global connections for all the pixels comprising a set of enable lines 632, allowing either the frame A sample/hold circuits or the frame B sample/hold circuits to drive the pixel electrodes.

The region of the CMOS substrate of SLM outside the active matrix pixel area 1006 comprises, inter alia, a charge pump for providing the ‘high’ voltage used by the MEMS pixels, one or a plurality of D/A converters, and in preferred embodiments also memory and I/O circuitry.

In one exemplary mode of operation the controller 202 writes data into the frame A sample/hold circuits whilst controlling the SLM to output the frame B sample/hold analogue voltages to the pixel electrodes. The illumination line 208 is then controlled to blank the laser(s) and then the frame A sample/hold circuits are enabled to output their analogue voltage data to the pixel electrodes and the outputs from the frame B sample/hold circuits are disabled. The laser(s) is/are then unblanked and analogue voltage data is written into the frame B sample/hold circuits whilst frame A is enabled for output. The laser(s) are then blanked, the multiplexer is switched once again the laser(s) are then unblanked, the process then looping back to the start.

Thus broadly speaking embodiments of the analogue MEMS pixel driver circuits we describe use two electrical circuits driving one pixel to relax the timing constraints: The diffractive pixel array needs to be stable for most of the clock cycle duration mode and is loaded with the analog values for the next frame display to improve the efficiency of the display (laser on duty cycle) and overall illumination level. Loading the analog information into the pixel array takes high power at high speed. In order to relax the timing and peak power requirements of the D/A and S/H circuits, each pixel can be driven by two S/H circuits in a ping-pong manner. While one set of S/H circuits are in hold mode and actively drive the pixel array, the other set of S/H circuits is in sample mode. The roles are reversed every frame. Switching between the two S/H circuits can be done very fast, orders of magnitude faster than loading accurate analog levels into the pixel array. One advantage of this is that the analog values can be loaded into the pixel array at a much lower speed, and this loading will not reduce the overall display duty cycle.

In embodiments of the SLM 100 one or more of the pixels may be replaced by a photodiode (not shown in FIG. 10), to facilitate in-plane sensing of a spatial intensity profile of a light beam illuminating the SLM. This is feasible in a diffractive imaging system because in such a system a small number (up to around 1%) of inactive SLM pixels does not produce visible defects in the reproduced image. Such a photodiode may be fabricated on the CMOS substrate and provided with an opening over the photodiode to permit the ingress of incident light. Where photodiodes are present in the active matrix area 1006 of the SLM the interface circuitry to the controller 202 may also be provided on the CMOS substrate outside the active matrix region (and data bus 204 may then be bidirectional). The photodiodes may be spatially distributed throughout the array: if a Gaussian intensity profile is assumed for an illuminating beam then, in principle, only 6 parameters need be determined to characterise the beam profile. For further information reference may be made to our earlier patent application GB1019749.9 filed 22 Nov. 2010, which is hereby incorporated by reference in its entirety for all purposes.

No doubt many other effective alternatives will occur to the skilled person. It will be understood that the invention is not limited to the described embodiments and encompasses modifications apparent to those skilled in the art lying within the spirit and scope of the claims appended hereto.

What is claimed is:

1. An analogue optical MEMS spatial light modulator (SLM) comprising a substrate bearing a plurality of light modulating MEMS pixels, each of said light modulating pixels comprising a pixel electrode and a mirror mounted on a hinge or spring to provide an analogue variable displacement, wherein said substrate further comprises:
an analogue pixel driver circuit for each of said optical phase modulating MEMS pixels coupled to said pixel electrode of the pixel, wherein said pixel driver circuit is configured to apply an analogue voltage to said pixel electrode to move said mirror by an analogue displacement; and
wherein said analogue pixel driver circuit comprises:
a pixel voltage input to receive a said analogue voltage;
a first sample/hold circuit coupled to said pixel voltage input and having a first sample/hold output, at least one select line coupled to said first sample/hold circuit to control sampling of said analogue voltage by said first sample/hold circuit, and a first capacitor coupled between said pixel voltage input and said first sample/hold output to store said sampled voltage.

2. An analogue optical MEMS SLM as claimed in claim 1 wherein said substrate further comprises one or more digital-to-analogue converters each coupled to a respective set of said pixel voltage inputs for a row or column of said SLM.

3. An analogue optical MEMS SLM as claimed in claim 1 wherein said analogue variable displacement comprises translation in a direction perpendicular to said substrate, wherein said mirror is mounted on a spring such that said mirror is able to translate in said direction perpendicular to said substrate substantially without tilting under the influence of a voltage applied to said pixel electrode, and wherein said pixel driver circuit is configured to apply an analogue voltage to said pixel electrode to translate said mirror by an analogue displacement in said perpendicular direction.

4. An analogue optical MEMS SLM as claimed in claim 3 wherein said pixel driver circuit further comprises a second sample/hold circuit coupled to said pixel voltage input and having a second sample/hold output, a second select line coupled to said second sample/hold circuit to control sampling of said analogue voltage by said second sample/hold circuit, and a second capacitor coupled between said pixel voltage input and said second sample/hold output to store said sampled voltage; and
a multiplexer having respective inputs coupled to said first and second sample/hold outputs, having a multiplexer output coupled to said pixel electrode, and having at least one multiplexer select line to control said multiplexer to selectively couple said first and second sample/hold outputs to said pixel electrode.

5. An analogue optical MEMS SLM as claimed in claim 4 wherein each of said first and second sample/hold circuits comprises a first sample circuit coupled to said pixel voltage input and to a column select line of said SLM, and a second sample circuit coupled in series between said first sample circuit and said multiplexer and to a row select line of said SLM.

6. An analogue optical MEMS SLM as claimed in claim 5 wherein said first sample circuit is shared between first and second sample/hold circuits.

7. An analogue optical MEMS SLM as claimed in claim 4 wherein said first and second sample/hold select lines are both connected to row select lines of said SLM.

8. An image display system including an analogue optical MEMS SLM as claimed in claim 4 further comprising a display controller coupled to said first and second sample/hold select lines and to said multiplexer select lines of said analogue pixel driver circuits, and wherein said display controller is configured to control said first and second sample/hold select lines to write image display data for pixels of a first image frame to said first sample/hold circuits for storage whilst controlling said multiplexer control lines to couple analogue image display data stored in said second sample/hold circuits to said pixel electrodes, and then to write image display data for pixels of a second image frame to said second sample/hold circuits for storage whilst controlling said multiplexer control lines to couple analogue image display data stored in said first sample/hold circuits to said pixel electrodes.

9. An image display system as claimed in claim 8 further comprising a controllable illumination source configured to illuminate said SLM, and wherein said display controller is configured to blank said controllable illumination source during switching of said multiplexer control lines.

10. A holographic image display system comprising an image display system as claimed in claim 8 further comprising a second SLM and Fourier transform optics between said analogue optical MEMS SLM and said second SLM to project a far field of said analogue optical MEMS SLM onto said second SLM.

11. An analogue optical MEMS spatial light modulator (SLM) comprising a substrate bearing a plurality of optical phase modulating MEMS pixels, each of said MEMS pixels comprising a pixel electrode and a mirror mounted on a spring such that said mirror is able to translate in a direction perpendicular to said substrate substantially without tilting, under the influence of a voltage applied to said pixel electrode, wherein said substrate further comprises:
an analogue pixel driver circuit for each of said optical phase modulating MEMS pixels coupled to said pixel electrode of the pixel, wherein said pixel driver circuit is configured to apply an analogue voltage to said pixel electrode to translate said mirror by an analogue displacement in said perpendicular direction; and
wherein said analogue pixel driver circuit comprises:
a pixel voltage input to receive a said analogue voltage;
a first sample/hold circuit coupled to said pixel voltage input and having a first sample/hold output;
a second sample/hold circuit coupled to said pixel voltage input and having a second sample/hold output;
first and second sample/hold select lines coupled to said first and second sample/hold circuits; and
a multiplexer having respective inputs coupled to said first and second sample/hold outputs, having a multiplexer output coupled to said pixel electrode, and having at least one multiplexer select line to control said multiplexer to selectively couple said first and second sample/hold outputs to said pixel electrode.

12. An analogue optical MEMS SLM as claimed in claim 11 wherein said substrate further comprises one or more digital-to-analogue converters each coupled to a respective set of said pixel voltage inputs for a row or column of said SLM.

13. An analogue optical MEMS SLM as claimed in claim 11 wherein each of said first and second sample/hold circuits comprises a first sample circuit coupled to said pixel voltage input and to a column select line of said SLM, and a second sample circuit coupled in series between said first sample circuit and said multiplexer and to a row select line of said SLM.

14. An analogue optical MEMS SLM as claimed in claim 13 wherein said first sample circuit is shared between first and second sample/hold circuits.

15. An analogue optical MEMS SLM as claimed in claim 11 wherein said first and second sample/hold select lines are both connected to row select lines of said SLM.

16. An analogue optical MEMS SLM as claimed in claim 11 incorporated into an image display system, the image display system further comprising a display controller coupled to said first and second sample/hold select lines and to said multiplexer select lines of said analogue pixel driver circuits, and wherein said display controller is configured to control said first and second sample/hold select lines to write image display data for pixels of a first image frame to said first sample/hold circuits for storage whilst controlling said multiplexer control lines to couple analogue image display data stored in said second sample/hold circuits to said pixel electrodes, and then to write image display data for pixels of a second image frame to said second sample/hold circuits for storage whilst controlling said multiplexer control lines to couple analogue image display data stored in said first sample/hold circuits to said pixel electrodes.

17. An image display system as claimed in claim 16 further comprising a controllable illumination source configured to illuminate said SLM, and wherein said display controller is configured to blank said controllable illumination source during switching of said multiplexer control lines.

18. An image display system as claimed in claim 16, wherein said image display system is a holographic image display system, the holographic image display system further comprising a second SLM and Fourier transform optics between said analogue optical MEMS SLM and said second SLM to project a far field of said analogue optical MEMS SLM onto said second SLM.
